(19) United States
(12) Patent Application Publication
(10) Pub. No.: US 2016/0214575 A1
(43) Pub. Date: Jul. 28, 2016

(54) WIPER BLADE

(71) Applicant: Yuhua WANG, Beijing (CN)

(72) Inventor: Yuhua WANG, Beijing (CN)

(21) Appl. No.: 14/913,996

(22) PCT Filed: Sep. 5, 2014
(86) PCT No.: PCT/CN2014/086041

§ 371 Date: Feb. 24, 2016

(30) Foreign Application Priority Data
Sep. 6, 2013 (CN) 201320551224.2
May 13, 2014 (CN) 201410201143.9

(51) Int. Cl. B60S 1/38

(52) U.S. Cl. CPC B60S 1/38; B60S 2001/3837

(57) ABSTRACT

The present invention provides a wiper blade, the wiper blade comprises: a wiper frame including an elastic main frame, a connector, an elastic sub-frame, and hanging hooks for hanging-up the sub-frame through the main frame; and a rubber wiper strip which is hung-up by the sub-frame, the wiper strip having a web sheet to be in contact with a windshield glass, one surface of the web sheet being a smooth surface, the other surface of the web sheet being provided with protrusions which are densely arranged for performing sweeping. The wiper strip has a non-symmetric configuration with respect to a y axis in an x axis, and the non-symmetric configuration is made so that a thickness of a half in which the protrusions are provided of the web sheet is greater than a thickness of a half in which the smooth surface is present of the web sheet.

### CROSS-REFERENCE TO RELATED APPLICATIONS

This application is the U.S. National Stage of International Patent Application No. PCT/CN2014/086041 filed on Sep. 5, 2014, which claims the benefit of and priority to Chinese Patent Application No. 201320551224.2 filed on Sep. 6, 2013 and Chinese Patent Application No. 201410201143.9 filed on May 13, 2014, the disclosures of which are hereby incorporated in their entireties by reference.

### FIELD OF THE INVENTION

The present invention relates to an improved wiper blade used for a windshield glass of an automobile. More specifically, the present invention relates to a wiper blade which has a function of sweeping granular dirt on the windshield glass off in addition to a function of scraping rainwater on the windshield glass off.

### BACKGROUND OF THE INVENTION

The present applicant has filed the following patent applications concerning a wiper blade: CN201110129549.7 and CN201110156324.0. The involved wiper blade has a favorable function of scraping rainwater off, but lacks a function of sweeping granular dirt off. The granular dirt mentioned contains dust, mud, bugs, guano and the like. The present invention provides a wiper blade having the function of sweeping granular dirt in addition to the function of scraping rainwater.

### SUMMARY OF THE INVENTION

The present invention provides a wiper blade, the wiper blade comprises (1) a wiper frame including an elastic main frame, a connector connected to a wiper arm of an automobile, an elastic sub-frame, and a plurality of hanging hooks for hanging-up the sub-frame through the main frame; and (2) a wiper strip made of rubber hung-up by the sub-frame, the wiper strip having an erective web sheet to be in contact with a windshield glass of the automobile, one surface of the web sheet being a smooth surface, the other surface of the web sheet being provided with a plurality of protrusions which are densely arranged for performing sweeping, wherein the wiper strip has a non-symmetric configuration with respect to a vertical axis, i.e. a y axis, in a horizontal axis, i.e. an x axis, and the non-symmetric configuration is made so that a thickness of a half in which the protrusions are provided of the web sheet is greater than a thickness of a half in which the smooth surface is present of the web sheet.

Wherein the number of the wiper strip is 1 or 2. Wherein in case of two wiper strips, the two wiper strips are arranged parallel to each other, two surfaces which face inward to each other of two web sheets of the two wiper strips are smooth surfaces, and two surfaces which face outward away from each other of the two web sheets of the two wiper strips are provided with the protrusions. Wherein at a position where the height is ½ of a height of the web sheet, a ratio of a thickness t′ of the half in which the protrusions are provided of the web sheet to a thickness t of the half in which the smooth surface is present of the web sheet is within the following range: t′/t=1.05˜2.5. Wherein the half in which the protrusions are provided of the web sheet has an outer surface which extends in the vertical direction, i.e. the direction of the y axis, into a substantially S-shaped outline, and a height of a projection point which projects outward to the maximum extent is within the range of ¼˜¾ of the height of the web sheet. Wherein the non-symmetric configuration is made so that two second grooves are provided between a base plate of a wiping web and a second horizontal plate of the wiper strip, and a depth of the second groove above the half in which the protrusions are provided is smaller than a depth of the second groove above the half in which the smooth surface is present. Wherein the non-symmetric configuration is made so that a second post is provided between a base plate of a wiping web and a second horizontal plate of the wiper strip, and a lower end in a vertical direction of the second post is deflected toward the half in which the smooth surface is present of the web sheet with respect to the y axis. Wherein on one surface or two surfaces of the web sheet of the wiper strip, the plurality of protrusions are arranged into 1˜5 rows above an end surface to be in contact with the windshield glass of the wiper strip in a longitudinal direction of the wiper strip, and cross sections of the protrusions perpendicular to a protruding direction thereof have arched contours. Wherein the cross sections of the protrusions perpendicular to the protruding direction thereof are crescent or circular or elliptic or olivary or spindly. Wherein 2˜5 rows of the protrusions are arranged in the longitudinal direction of the wiper strip, and the protrusions in adjacent two rows are arranged to be staggered with respect to each other. Wherein the protrusions are not connected to each other but separately arranged. Wherein the protrusions in the same row are connected to each other and continuously arranged. Wherein 2˜30 protrusions are connected into a group, one group is disconnected from another group in the same row, and the protrusions of respective groups in adjacent two rows are arranged to be staggered with respect to each other. Wherein the cross sections of the protrusions are tapered in the protruding direction of the protrusions. Wherein an included angle of 30°˜90° is formed between a vertical axis of the wiper strip and an axis in the protruding direction of the protrusions.

Another implementation of the present invention provides a wiper blade, the wiper blade comprises (1) a wiper frame including an elastic main frame, a connector connected to a wiper arm of an automobile, an elastic sub-frame, and a plurality of hanging hooks for hanging-up the sub-frame through the main frame; and (2) a wiper strip made of rubber hung-up by the sub-frame, the wiper strip having an erective web sheet to be in contact with a windshield glass of the automobile, one surface of the web sheet being a smooth surface, the other surface of the web sheet being provided with a plurality of protrusions which are densely arranged for performing sweeping, wherein the wiper strip has a non-symmetric configuration with respect to a vertical axis, i.e. a y axis, in a horizontal axis, i.e. an x axis, and the non-symmetric configuration is made so that two second grooves are provided between a base plate of a wiping web and a second horizontal plate of the wiper strip, and a depth of the second groove above the half in which the protrusions are provided is smaller than a depth of the second groove above the half in which the smooth surface is present.

Wherein the number of the wiper strip is 1 or 2. Wherein in case of two wiper strips, the two wiper strips are arranged parallel to each other, two surfaces which face inward to each other of two web sheets of the two wiper strips are smooth surfaces, and two surfaces which face outward away from each other of the two web sheets of the two wiper strips are provided with the protrusions. Wherein a ratio of a depth d′ of the second groove above the half in which the protrusions are provided to a depth d of the second groove above the half in which the smooth surface is present is within the following range: d′/d=0.2˜0.95. Wherein the non-symmetric configuration is made so that a thickness of a half in which the protrusions are provided of the web sheet is greater than a thickness of a half in which the smooth surface is present of the web sheet. Wherein on one surface or two surfaces of the web sheet of the wiper strip, the plurality of protrusions are arranged into 1˜5 rows above an end surface to be in contact with the windshield glass of the wiper strip in a longitudinal direction of the wiper strip, and cross sections of the protrusions perpendicular to a protruding direction thereof have arched contours. Wherein the cross sections of the protrusions perpendicular to the protruding direction thereof are crescent or circular or elliptic or olivary or spindly. Wherein 2˜5 rows of the protrusions are arranged in the longitudinal direction of the wiper strip, and the protrusions in adjacent two rows are arranged to be staggered with respect to each other. Wherein the protrusions are not connected to each other but separately arranged. Wherein the protrusions in the same row are connected to each other and continuously arranged. Wherein 2˜30 protrusions are connected into a group, one group is disconnected from another group in the same row, and the protrusions of respective groups in adjacent two rows are arranged to be staggered with respect to each other. Wherein the cross sections of the protrusions are tapered in the protruding direction of the protrusions. Wherein an included angle of 30°˜90° is formed between a vertical axis of the wiper strip and an axis in the protruding direction of the protrusions.

Another implementation of the present invention provides a wiper blade, the wiper blade comprises (1) a wiper frame including an elastic main frame, a connector connected to a wiper arm of an automobile, an elastic sub-frame, and a plurality of hanging hooks for hanging-up the sub-frame through the main frame; and (2) a wiper strip made of rubber hung-up by the sub-frame, the wiper strip having an erective web sheet to be in contact with a windshield glass of the automobile, one surface of the web sheet being a smooth surface, the other surface of the web sheet being provided with a plurality of protrusions which are densely arranged for performing sweeping, wherein the wiper strip has a non-symmetric configuration with respect to a vertical axis, i.e. a y axis, in a horizontal axis, i.e. an x axis, and the non-symmetric configuration is made so that a second post is provided between a base plate of a wiping web and a second horizontal plate of the wiper strip, and a lower end in a vertical direction of the second post is deflected toward the half in which the smooth surface is present of the web sheet with respect to the y axis.

Wherein the number of the wiper strip is 1 or 2. Wherein in case of two wiper strips, the two wiper strips are arranged parallel to each other, two surfaces which face inward to each other of two web sheets of the two wiper strips are smooth surfaces, and two surfaces which face outward away from each other of the two web sheets of the two wiper strips are provided with the protrusions. Wherein a deflected angle a by which the vertical direction of the second post is deflected with respect to the y axis is within the range of ∠a=2°˜30°. Wherein the non-symmetric configuration is made so that a thickness of a half in which the protrusions are provided of the web sheet is greater than a thickness of a half in which the smooth surface is present of the web sheet. Wherein on one surface or two surfaces of the web sheet of the wiper strip, the plurality of protrusions are arranged into 1˜5 rows above an end surface to be in contact with the windshield glass of the wiper strip in a longitudinal direction of the wiper strip, and cross sections of the protrusions perpendicular to a protruding direction thereof have arched contours. Wherein the cross sections of the protrusions perpendicular to the protruding direction thereof are crescent or circular or elliptic or olivary or spindly. Wherein 2˜5 rows of the protrusions are arranged in the longitudinal direction of the wiper strip, and the protrusions in adjacent two rows are arranged to be staggered with respect to each other. Wherein the protrusions are not connected to each other but separately arranged. Wherein the protrusions in the same row are connected to each other and continuously arranged. Wherein 2˜30 protrusions are connected into a group, one group is disconnected from another group in the same row, and the protrusions of respective groups in adjacent two rows are arranged to be staggered with respect to each other. Wherein the cross sections of the protrusions are tapered in the protruding direction of the protrusions. Wherein an included angle of 30°˜90° is formed between a vertical axis of the wiper strip and an axis in the protruding direction of the protrusions.

Another implementation of the present invention provides a wiper strip of a wiper blade used on a car, the wiper strip comprising a web sheet for contacting a windshield glass, wherein on one surface or two surfaces of the web sheet of the wiper strip, a plurality of protrusions are arranged into 1˜5 rows above an end surface to be in contact with the windshield glass of the wiper strip in a longitudinal direction of the wiper strip, and cross sections of the protrusions perpendicular to a protruding direction thereof have arched contours.

Wherein the cross sections of the protrusions perpendicular to the protruding direction thereof are crescent or circular or elliptic or olivary or spindly. Wherein 2˜5 rows of the protrusions are arranged in the longitudinal direction of the wiper strip, and the protrusions in adjacent two rows are arranged to be staggered with respect to each other. Wherein an included angle of 30°˜90° is formed between a vertical axis of the wiper strip and an axis in the protruding direction of the protrusions.

### BRIEF DESCRIPTION OF THE DRAWINGS

FIG. 1 is a schematic diagram showing a general structure of a wiper blade according to the present invention.

FIG. 2 is a schematic perspective diagram showing an end section of a sub-frame of the wiper blade according to the present invention.

FIG. 3 is a schematic perspective diagram showing an end section of a wiper strip of the wiper blade according to the present invention.

FIG. 4 is a sectional view taken along an S-S line in FIG. 1, showing a basic configuration of the wiper blade according to the present invention.

FIG. 5 is a schematic diagram showing an improved wiper strip according to a first implementation of the present invention.

FIG. 6 is a schematic diagram showing an improved wiper strip according to a second implementation of the present invention.

FIG. 7 is a schematic diagram showing an improved wiper strip according to a third implementation of the present invention.

FIG. 8 is a schematic diagram showing an improved wiper strip according to a fourth implementation of the present invention.

FIG. 9 is a schematic diagram showing an improved wiper strip according to a fifth implementation of the present invention.

FIG. 10 is a schematic diagram showing an alternative of the first implementation of the present invention.

FIGS. 11 and 12 are schematic diagrams showing that the wiper blade according to the present invention wipes a windshield glass of an automobile.

FIGS. 13 to 15 are schematic diagrams showing a first form of protrusions on the wiper strip according to the present invention.

FIGS. 16 to 18 are schematic diagrams showing a second form of the protrusions on the wiper strip according to the present invention.

FIGS. 19 to 21 are schematic diagrams showing a third form of the protrusions on the wiper strip according to the present invention.

FIGS. 22 to 24 are schematic diagrams further illustrating the protrusions of the wiper strip according to the present invention.

### DETAILED DESCRIPTION OF THE PREFERRED EMBODIMENTS

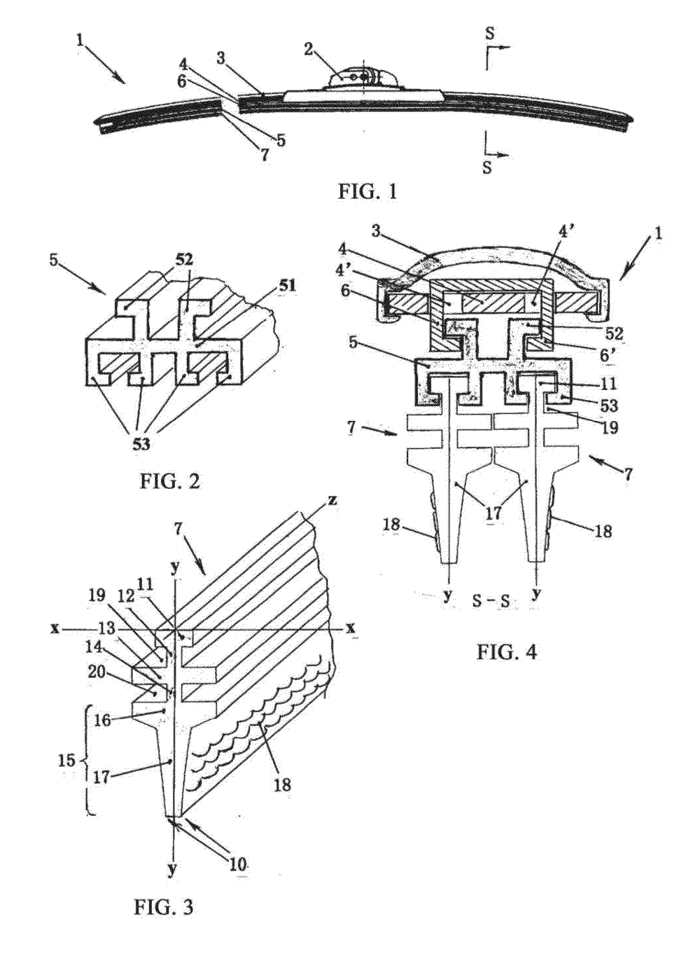

FIG. 1 is a schematic diagram showing a general structure of a wiper blade 1 according to the present invention. The wiper blade 1 includes a connector 2 to be connected to a wiper arm of an automobile, a top cap 3, a main frame 4 made of an elastic metal, a plurality of hanging hooks 6 arranged along a full length of the wiper blade, a sub-frame 5 made of a flexible plastic or an elastic metal, and a wiper strip 7 made of a rubber and suspended by the sub-frame 5. The above mentioned connector 1, the top cap 3, the main frame 4, the hanging hooks 6 and the sub-frame 5 constitute a wiper frame of the wiper blade.

FIG. 2 is a partial perspective diagram or a schematic diagram showing an end section of the sub-frame 5 of the wiper blade according to the present invention (also with reference to FIG. 4). A reference numeral 51 denotes a main beam plate of the sub-frame 5. A reference numeral 52 denotes a pair of reverse hanging claws (which extend upward) on the main beam plate 51, and legs 6′ of the hanging hooks 6 catch the reverse hanging claws 52 and are hung up to the main frame 4. A reference numeral 53 denotes two pairs of hanging claws under the main beam plate 51, and the two pairs of hanging claws 53 are respectively inserted into a pair of first grooves 19 of each of two wiper strips 7, raise first horizontal plates 11 of the wiper strips 7 upward, and lift the wiper strips 7 up. In some implementations, the number of the wiper strip is one rather than two, in which case the sub-frame 5 only has a pair of the hanging claws 53 (this case is not shown in FIGS. 2 and 4).

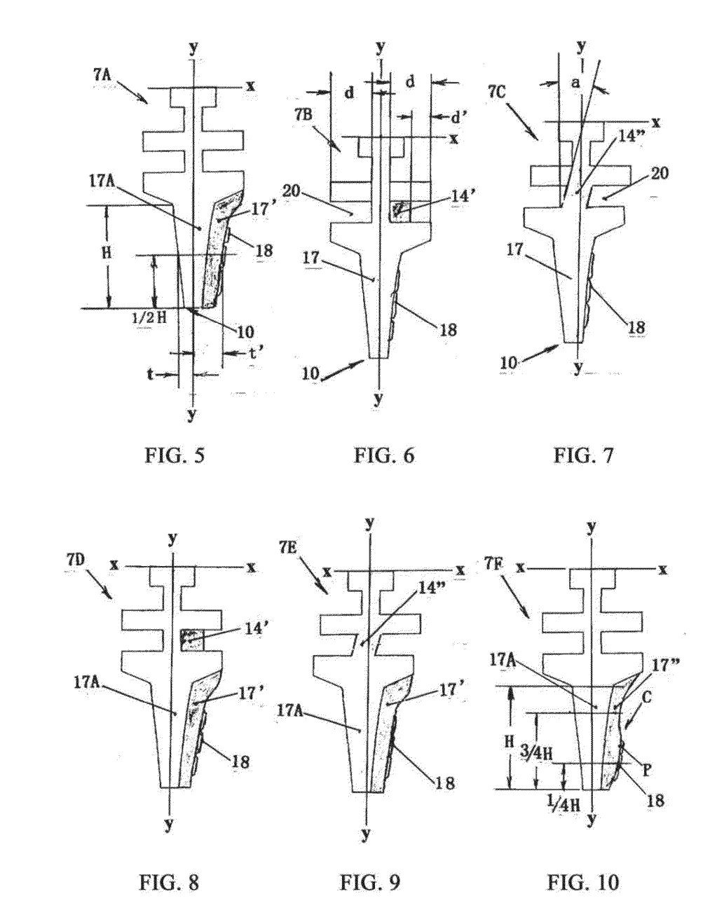

FIG. 3 is a partial perspective diagram or a schematic diagram showing an end section of the wiper strip 7 of the wiper blade according to the present invention. Reference numerals “x”, “y” and “z” in FIG. 3 indicate coordinate axes in horizontal, vertical and depth directions respectively. A reference numeral 11 denotes a first horizontal plate of the wiper strip 7. A reference numeral 13 denotes a second horizontal plate. A reference numeral 15 denotes a wiping web, the wiping web 15 includes a base plate 16 and a web sheet 17, and a pair of end edges 10 for scraping rainwater on a glass surface off are provided on a bottom end of the web sheet 17. A first post 12 is provided between the first horizontal plate 11 and the second horizontal plate 13, and a pair of first grooves 19 are provided on both sides of the first post 12. A second post 14 is provided between the base plate 16 of the wiping web and the second horizontal plate 13, and a pair of second grooves 20 are provided on both sides of the second post 14. The web sheet 17 is erective, one of two surfaces on both sides of which is provided with protrusions 18 for sweeping dirt on the glass surface, and the other of the two surfaces is smooth. In FIG. 3, the both sides of the wiper strip 7, particularly the web sheet 17, are symmetrical with respect to the y axis, which has been implemented in the prior art, and features of the present invention will be described in connection with FIGS. 5 to 24.

FIG. 4 is a sectional view taken along an S-S line in FIG. 1, showing a basic configuration of the wiper blade according to the present invention. The main frame 4 has two holes 4′ at that position shown in the sectional view, two legs 6′ of each of the hanging hooks 6 are hung down through the holes to catch the reverse hanging claws 52 so that the sub-frame 5 is hung up. The two pairs of hanging claws 53 are respectively inserted into the pair of first grooves 19 of each of the two wiper strips 7, raise the first horizontal plates 11 of the wiper strips 7 upward, and lift the two wiper strips 7 up. In FIG. 4, the two wiper strips 7 are arranged parallel to each other. The two web sheets 17 have smooth surfaces which face inward to each other as well as sweeping surfaces which face outward away from each other, and each of the sweeping surfaces has the protrusions 18. In FIG. 4, the both sides of each wiper strip 7, particularly each web sheet 17, are symmetrical with respect to the y axis, which has been implemented in the prior art, and features of the present invention will be described in connection with FIGS. 5 to 24.

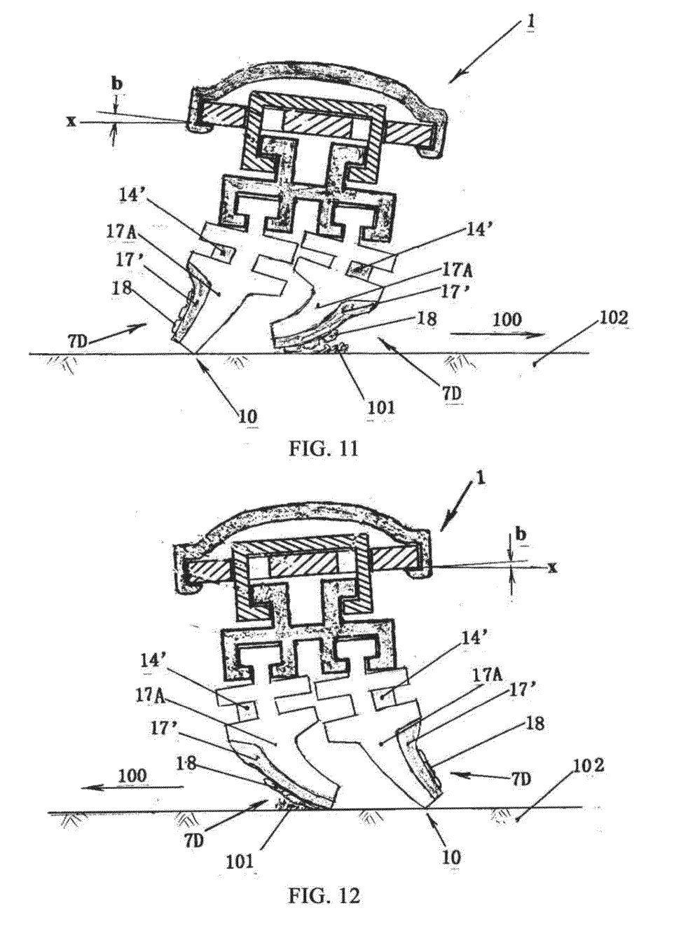

FIG. 5 is a schematic diagram showing an improved wiper strip 7A according to a first implementation of the present invention. A majority of the structure of the wiper strip has been described with reference to FIG. 3 with the exception that a web sheet 17A is non-symmetrical with respect to the y axis. That is, a right half of the web sheet 17A in which the protrusions 18 are provided on the surface has a thickened portion 17′ (represented by a portion drawn in gray), and thus the web sheet 17A exhibits a non-symmetric shape. Such a configuration is employed in order that when the web sheet 17A of the wiper strip 7A abuts against the glass surface and wipes rightward in the direction of the x axis, the web sheet is liable to be bent and the protrusions 18 is apt to approach the glass surface and sweep the dirt on the glass surface off; and when the web sheet 17A of the wiper strip 7A abuts against the glass surface and wipes leftward in the direction of the x axis, the web sheet is not liable to be bent due to an additional resistance of the thickened portion 17′ and one of the two end edges 10 just abuts against the glass surface at an appropriate angle to obtain a favorable water scraping function as a result of less bending of the web sheet. With regard to the description of this part, please refer to FIGS. 11 and 12. In FIG. 5, a reference numeral H indicates a height of the web sheet 17A. At a position where the height is ½ H, a thickness of a left half (the side on which the surface is smooth) of the web sheet is t, a thickness of the right half (the side on which the protrusions are provided on the surface) of the web sheet is t′, and a ratio of the thicknesses of the both halves is within the following range: t′/t=1.05˜2.5.

FIG. 10 is a schematic diagram showing a wiper strip 7F according to an alternative of the first implementation of the present invention. In this implementation, a thickened portion 17″ of the web sheet has an outer surface which extends in the vertical direction, i.e. the direction of the y axis, into a substantially S-shaped outline C. A height of a projection point P which projects outward to the maximum extent is within the range of ¼˜¾ of the height H of the web sheet, i.e. the range of ¼ H˜¾ H. Such a configuration has the following advantage: when the web sheet abuts against the glass surface and wipes rightward in the direction of the x axis, the protrusions 18 is apt to approach the glass surface and sweep the dirt on the glass surface off.

FIG. 6 is a schematic diagram showing an improved wiper strip 7B according to a second implementation of the present invention. In FIG. 6, the pair of second grooves 20 on left and right sides are provided between the base plate 16 of the wiping web and the second horizontal plate 13 of the wiper strip 7B. The second groove 20 on the left side (the side on which the surface is smooth) has a usual depth d, while the second groove 20 on the right side (the side on which the protrusions are present in the surface) is filled with a rubber material 14′ (represented by a portion drawn in gray). In other words, it means that the second post 14 between the base plate 16 of the wiping web and the second horizontal plate 13 is widened rightward to decrease a depth d′ of the second groove on the right side, i.e. d′<d, and thus the wiper strip 7B is non-symmetrical in the left-right direction with respect to the y axis. Likewise, when the web sheet of the wiper strip 7B abuts against the glass surface and wipes rightward in the direction of the x axis, the web sheet is liable to be bent and the protrusions 18 is apt to approach the glass surface and sweep the dirt on the glass surface off; and when the web sheet of the wiper strip 7B abuts against the glass surface and wipes leftward in the direction of the x axis, the web sheet is not liable to be bent owing to the decrease of the depth of the second groove on the right side (due to an additional resistance of the widened portion 14′) and one of the two end edges 10 just abuts against the glass surface at an appropriate angle to obtain a favorable water scraping function as a result of less bending of the web sheet.

In FIG. 6, a ratio of the depths d and d′ of the second grooves on the left and right sides is within an appropriate range of d′/d=0.2˜0.95.

FIG. 7 is a schematic diagram showing an improved wiper strip 7C according to a third implementation of the present invention. In FIG. 7, the second post 14 between the base plate 16 of the wiping web and the second horizontal plate 13 is modified from its original vertically erective state into a second post 14″ a lower end of which is deflected leftward. At this time, the lower end in a vertical direction of the second post is deflected toward the half in which the smooth surface is present of the web sheet with respect to the y axis, that is, a vertical section of the second post is transformed from a rectangle into a parallelogram in which the lower end of the second post is deflected leftward, and thus the wiper strip 7C is non-symmetrical in the left-right direction with respect to the y axis. A deflected angle a is within an appropriate range of ∠a=2°˜30°. After such modification, when the web sheet of the wiper strip 7C abuts against the glass surface and wipes rightward in the direction of the x axis, the web sheet is liable to be bent since the parallelogrammic second post 14″ is pressed in a short diagonal direction of the parallelogram, and the protrusions 18 is apt to approach the glass surface and sweep the dirt on the glass surface off; and when the web sheet of the wiper strip 7C abuts against the glass surface and wipes leftward in the direction of the x axis, the web sheet is not liable to be bent since the parallelogrammic second post 14″ is pressed in a long diagonal direction of the parallelogram, and one of the two end edges 10 just abuts against the glass surface at an appropriate angle to obtain a favorable water scraping function as a result of less bending of the web sheet.

FIG. 8 is a schematic diagram showing an improved wiper strip 7D according to a fourth implementation of the present invention. The present implementation combines the first implementation shown in FIG. 5 and the second implementation shown in FIG. 6 together to enhance practical effects brought about by basic concepts of the invention. The details thereof have been described in the foregoing and will not be repeated.

FIG. 9 is a schematic diagram showing an improved wiper strip 7E according to a fifth implementation of the present invention. The present implementation combines the first implementation shown in FIG. 5 and the third implementation shown in FIG. 7 together to enhance practical effects brought about by basic concepts of the invention. The details thereof have been described in the foregoing and will not be repeated.

FIG. 11 is a schematic diagram showing that the wiper strips 7 of the wiper blade 1 shown in FIG. 4 are substituted with the wiper strip 7D according to the fourth implementation of the invention shown in FIG. 8 and simulating that the wiper blade 1 wipes rightward (as shown by an arrow 100) on a windshield glass 102 of an automobile. It can be seen from FIG. 11 that the two wiper strips of the wiper blade are subjected to a downward pressure and bent since the wiper arm of the automobile exerts the downward pressure. As described above, under the same pressure, the right wiper strip 7D is liable to be bent with the side on which the protrusions are provided on the web sheet facing forward so that the protrusions 18 is apt to approach the glass surface and sweep the dirt on the glass surface off. The left wiper strip 7D immediately follows the right wiper strip 7D. Also as described above, the left wiper strip 7D is not liable to be bent with the side on which the smooth surface is provided on the web sheet facing forward due to the additional resistance of the thickened portion so that one of the two end edges 10 on a lower end of the web sheet abuts against the glass surface at an appropriate angle to scrape rainwater off. In this way, while the wiper blade takes one (unidirectional) stroke, the leading wiper strip sweeps the dirt on the glass surface and the next wiper strip then scrapes the rainwater on the glass surface so that the quality and efficiency for sweeping the dirt off and scraping the rainwater off are improved. Since there is no or little dirt on the glass surface to be scrubbed by the next wiper strip, the next wiper strip mainly serves to scrape the rainwater and the glass surface scrubbed by the next wiper strip is apt to form a desirable water film without producing defects such as “water line”, “painted face” and the like which are common when the existing wiper blades are used. Since the right wiper strip is pressed downward to be bent more, the right side of the wiper blade is sunk to a larger extent, and since the left wiper strip is pressed downward to be bent less, the left side of the wiper blade is sunk to a smaller extent. Thus, an inclined angle b in FIG. 11 by which the wiper blade deviates from the horizontal axis (the x axis) is formed. Since the angle b is not very large, a tolerance clearance in combining the wiper arm of the automobile, the connector of the wiper blade, and the wiper blade itself usually can tolerate the inclined angle.

FIG. 12 is substantially the same as FIG. 11 except that the sweeping is performed leftward (as shown by the arrow 100), that is, in a direction opposite to the sweeping direction in FIG. 11. Other description thereof is similar to that of FIG. 11 and will not be repeated.

The description of the wiper strip 7D according to the fourth implementation of the invention shown in FIG. 8 has been given above. Likewise, the similar effects are obtained if the wiper strips of the wiper blade 1 shown in FIG. 11 or 12 are substituted with the wiper strips shown in FIGS. 5 to 7 and FIGS. 9 and 10 or wiper strips fabricated by the same inventive concepts.

Furthermore, the description of the wiper blade mounted with two wiper strips has been given above with reference to FIGS. 5 to 12. It is conceivable that the similar effects can be obtained by installing only one wiper strip on the wiper blade. The difference lies in that while the wiper blade performs reciprocating strokes in operation, the stroke in one direction mainly functions to sweep the dirt by means of the protrusions on the web sheet, and the stroke in the other direction mainly functions to scrape the rainwater by means of the smooth surface and the end edge of the web sheet.

In the present description, the horizontal direction, i.e. the x direction, refers to a direction that is parallel to the windshield glass of the automobile and that is consistent with the direction in which the wiper blade makes sweeping; the vertical direction, i.e. the y direction, refers to a direction that is perpendicular to the windshield glass; and the z direction refers to a direction that is consistent with a longitudinal direction of the wiper blade or the wiper strip. The terms “leftward” and “rightward” respectively refer to left and right directions in the drawings. The terms “upward” and “downward” respectively refer to directions going away from the windshield glass and coming close to the windshield glass.

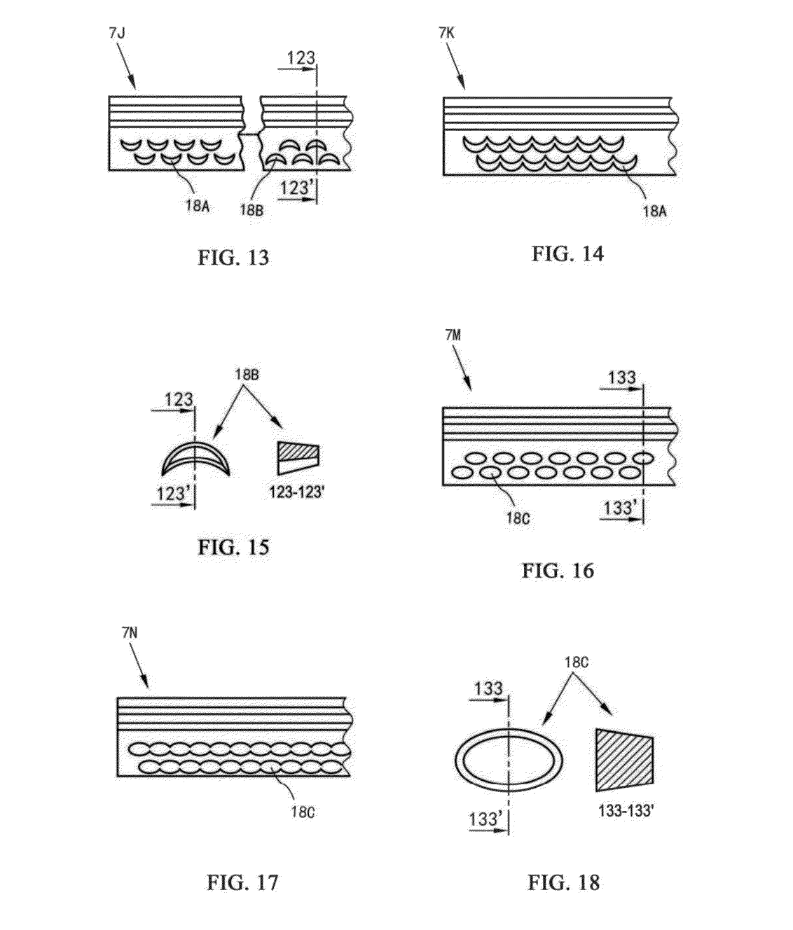

FIGS. 13 to 15 are schematic diagrams showing a first form of the protrusions on the wiper strip according to the present invention. A wiper strip 7J is provided with protrusions 18A and 18B. As seen from FIGS. 13 to 15, the protrusions 18A and 18B are provided to have a crescent shape in their top views, that is, the protrusions are crescent in their cross sections perpendicular to a protruding direction thereof. The crescent protrusions in a left portion of FIG. 13 are arranged so that the crescent shape is concave upward, and crescent protrusions in a right portion of FIG. 13 are arranged so that the crescent shape is concave downward. In FIG. 13, the protrusions are not connected to each other or continuous with each other but are separated from each other. These protrusions are arranged in line in the longitudinal direction of the wiper strip, usually 1˜5 rows of the protrusions may be arranged on one surface of the web sheet, and the protrusions in adjacent two rows are arranged to be staggered with respect to each other. The staggered arrangement is devised so that the protrusions in the next row can make supplementary sweeping once the protrusions in the previous row inexhaustively sweep the dirt. FIG. 14 is similar to FIG. 13 with the exception that protrusions of a wiper strip 7K are not separated from each other but are connected to each other in line. Alternatively, a number of protrusions are connected into a group, one group is disconnected from another group, and the protrusions in respective groups are arranged in line in the longitudinal direction of the wiper strip (this form is not shown in the drawings). Generally, each group may have 2˜30 protrusions. FIG. 15 is an enlarged diagram of the protrusions 18B, and the cross sections of the crescent protrusions are tapered like a slope in the protruding direction of the protrusions, that is, the cross sections of the protrusions are tapered in their protruding direction. A right portion of FIG. 15 is a sectional view taken along a 123-123′ line.

FIGS. 16 to 18 are schematic diagrams showing a second form of the protrusions on the wiper strip according to the present invention. A wiper strip 7M is provided with protrusions 18C. As seen from FIGS. 16 to 18, the protrusions 18C are provided to have an elliptic or olivary shape in their top views, that is, the protrusions are elliptic or olivary in their cross sections perpendicular to a protruding direction thereof. In FIG. 16, the protrusions 18C are not connected to each other or continuous with each other but are separated from each other. These protrusions are arranged in line in the longitudinal direction of the wiper strip, usually 1˜5 rows of the protrusions may be arranged on one surface of the web sheet, and the protrusions in adjacent two rows are arranged to be staggered with respect to each other. FIG. 17 is similar to FIG. 16 with the exception that protrusions 18C of a wiper strip 7N are not separated from each other but are connected to each other in line. Alternatively, a number of protrusions are connected into a group, one group is disconnected from another group, and the protrusions in respective groups are arranged in line in the longitudinal direction of the wiper strip (this form is not shown in the drawings). Generally, each group may have 2˜30 protrusions. FIG. 18 is an enlarged diagram of the protrusions 18C, and the cross sections of the crescent protrusions are tapered like a slope in the protruding direction of the protrusions, that is, the cross sections of the protrusions are tapered in their protruding direction. A right portion of FIG. 18 is a sectional view taken along a 133-133′ line.

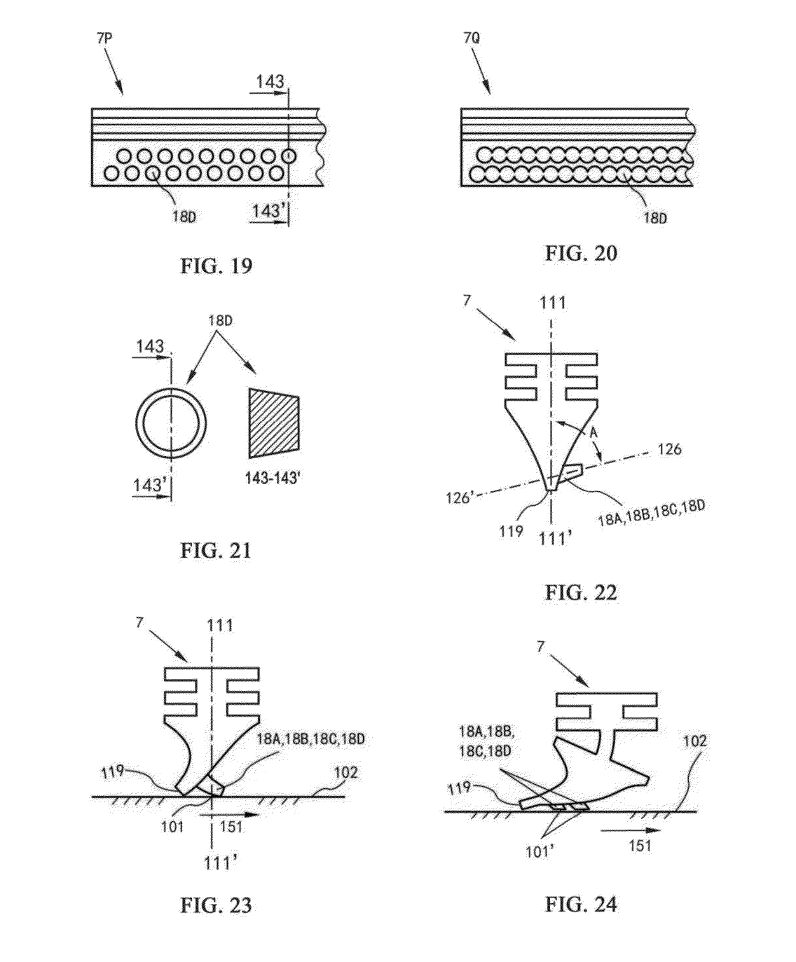

FIGS. 19 to 21 are schematic diagrams showing a third form of the protrusions on the wiper strip according to the present invention. A wiper strip 7P is provided with protrusions 18D. As seen from FIGS. 19 to 21, the protrusions 18D are provided to have a circular shape in their top views, that is, the protrusions are circular in their cross sections perpendicular to a protruding direction thereof. In FIG. 19, the protrusions are not connected to or continuous with each other but are separated from each other. These protrusions are arranged in line in the longitudinal direction of the wiper strip, usually 1˜5 rows of the protrusions may be arranged on one surface of the web sheet, and the protrusions in adjacent two rows are arranged to be staggered with respect to each other. FIG. 20 is similar to FIG. 19 with the exception that protrusions of a wiper strip 7Q are not separated from each other but are connected to each other in line. Alternatively, a number of protrusions are connected into a group, one group is disconnected from another group, and the protrusions in respective groups are arranged in line in the longitudinal direction of the wiper strip (this form is not shown in the drawings). Generally, each group may have 2˜30 protrusions. FIG. 21 is an enlarged diagram of the protrusions 18D, and the cross sections of the crescent protrusions are tapered like a slope in the protruding direction of the protrusions, that is, the cross sections of the protrusions are tapered in their protruding direction. A right portion of FIG. 21 is a sectional view taken along a 143-143′ line.

It can be known from the above description that the cross sections perpendicular to the protruding direction of the protrusions have arched contours to avoid straight lines. It aims to reduce edges or corners formed by straight lines to reduce stress concentration so that firmness and durability of the protrusions during stress deformation repeated for many times are improved. These three forms are given as an example, the present invention is not limited to them, and other types which meet the same requirement are possible. Moreover, the cross sections perpendicular to the protruding direction of the protrusions may have a constant uniform size or may be tapered (as shown in FIGS. 15, 18, 21), and the cross sections in base portions of the protrusions are increased in the latter manner so as to improve firmness and durability of the protrusions during stress deformation repeated for many times.

FIGS. 22 to 24 schematically show how the wiper blade provided with the protrusions for sweeping dirt operates. In FIG. 22, an included angle A indicating an inclination of the protrusions is formed between a vertical axis 111-111′ of the wiper strip 7 and an axis 126-126′ in a protruding direction of the protrusions 18A, 18B, 18C, 18D, and the included angle A is generally 30°˜90°. FIG. 23 shows a state in which the wiper strip 7 is bent and wipes in the direction shown by an arrow 151 because an end portion 119 of the wiper strip 7 is in contact with the windshield glass 102. The dirt stuck to the glass surface is removed by virtue of a forward sweeping force of the protrusions. In FIG. 23, a side surface 101 of a protrusion is in contact with the glass surface to sweep the dirt. FIG. 24 is similar to FIG. 23, but FIG. 24 indicates a state in which the wiper strip 7 are deformed to a larger extent when the wiper strip is soft or when the wiper blade presses the windshield glass with a greater pressure. At this time, top end surfaces of protrusions are in contact with the glass surface and function to clear the dirt off. Incidentally, the protrusions in FIGS. 22 to 24 are exaggeratedly drawn for clear expression, and they are actually not necessarily so big or so long as shown.

It is possible that one wiper strip is provided on one wiper blade. The web sheet of the wiper strip has two side surfaces for scraping rainwater, and the protrusions for sweeping granular dirt may be provided on only one of the side surfaces or may be provided on both of the side surfaces.

It is also possible that two wiper strips are provided on one wiper blade. These two wiper strips should be parallel to each other and close to each other. For each of the wiper strips, the side surface thereof which is adjacent to the other wiper strip is called as an inner side surface, and the other side surface thereof is called as an outer side surface. The protrusions are provided on the outer side surfaces of the two wiper strips, and the inner side surfaces of the two wiper strips are not provided with the protrusions but kept smooth (as shown in FIGS. 4, 11, 12). Such provisions have the following advantage: when the wiper blade wipes toward a direction, the smooth surface of one wiper strip scrapes the water immediately after the surface on which the protrusions are provided of the other wiper strip faces forward and sweeps the dirt; and when the wiper blade wipes toward an opposite direction, similarly, the smooth surface of one wiper strip scrapes the water immediately after the surface on which the protrusions are provided of the other wiper strip faces forward and sweeps the dirt. In this way, efficiency for cleaning the glass surface is improved.

What is claimed is:

1. A wiper blade, characterized in that it comprises
(1) a wiper frame including an elastic main frame, a connector connected to a wiper arm of an automobile, an elastic sub-frame, and a plurality of hanging hooks for hanging-up the sub-frame through the main frame; and
(2) a wiper strip made of rubber hung-up by the sub-frame, the wiper strip having an erective web sheet to be in contact with a windshield glass of the automobile, one surface of the web sheet being a smooth surface, the other surface of the web sheet being provided with a plurality of protrusions which are densely arranged for performing sweeping,
wherein the wiper strip has a non-symmetric configuration with respect to a vertical axis, i.e. a y axis, in a horizontal axis, i.e. an x axis, and the non-symmetric configuration is made so that a thickness of a half in which the protrusions are provided of the web sheet is greater than a thickness of a half in which the smooth surface is present of the web sheet.

2. The wiper blade according to claim 1, wherein the number of the wiper strip is 1 or 2.

3. The wiper blade according to claim 2, wherein in case of two wiper strips, the two wiper strips are arranged parallel to each other, two surfaces which face inward to each other of two web sheets of the two wiper strips are smooth surfaces, and two surfaces which face outward away from each other of the two web sheets of the two wiper strips are provided with the protrusions.

4. The wiper blade according to claim 1, wherein at a position where the height is ½ of a height of the web sheet, a ratio of a thickness t′ of the half in which the protrusions are provided of the web sheet to a thickness t of the half in which the smooth surface is present of the web sheet is within the following range: t′/t=1.05˜2.5.

5. The wiper blade according to claim 1, wherein the half in which the protrusions are provided of the web sheet has an outer surface which extends in the vertical direction, i.e. the direction of the y axis, into a substantially S-shaped outline, and a height of a projection point which projects outward to the maximum extent is within the range of ¼˜¾ of the height of the web sheet.

6. The wiper blade according to claim 1, wherein the non-symmetric configuration is made so that two second grooves are provided between a base plate of a wiping web and a second horizontal plate of the wiper strip, and a depth of the second groove above the half in which the protrusions are provided is smaller than a depth of the second groove above the half in which the smooth surface is present.

7. The wiper blade according to claim 1, wherein the non-symmetric configuration is made so that a second post is provided between a base plate of a wiping web and a second horizontal plate of the wiper strip, and a lower end in a vertical direction of the second post is deflected toward the half in which the smooth surface is present of the web sheet with respect to the y axis.

8. The wiper blade according to claim 1, wherein on one surface or two surfaces of the web sheet of the wiper strip, the plurality of protrusions are arranged into 1˜5 rows above an end surface to be in contact with the windshield glass of the wiper strip in a longitudinal direction of the wiper strip, and cross sections of the protrusions perpendicular to a protruding direction thereof have arched contours.

9. The wiper blade according to claim 8, wherein the cross sections of the protrusions perpendicular to the protruding direction thereof are crescent or circular or elliptic or olivary or spindly.

10. The wiper blade according to claim 8, wherein 2˜5 rows of the protrusions are arranged in the longitudinal direction of the wiper strip, and the protrusions in adjacent two rows are arranged to be staggered with respect to each other.

11. The wiper blade according to claim 8, wherein the protrusions are not connected to each other but separately arranged.

12. The wiper blade according to claim 8, wherein the protrusions in the same row are connected to each other and continuously arranged.

13. The wiper blade according to claim 12, wherein 2˜30 protrusions are connected into a group, one group is disconnected from another group in the same row, and the protrusions of respective groups in adjacent two rows are arranged to be staggered with respect to each other.

14. The wiper blade according to claim 8, wherein the cross sections of the protrusions are tapered in the protruding direction of the protrusions.

15. The wiper blade according to claim 8, wherein an included angle of 30°˜90° is formed between a vertical axis of the wiper strip and an axis in the protruding direction of the protrusions.

16. A wiper blade, characterized in that it comprises
(1) a wiper frame including an elastic main frame, a connector connected to a wiper arm of an automobile, an elastic sub-frame, and a plurality of hanging hooks for hanging-up the sub-frame through the main frame; and
(2) a wiper strip made of rubber hung-up by the sub-frame, the wiper strip having an erective web sheet to be in contact with a windshield glass of the automobile, one surface of the web sheet being a smooth surface, the other surface of the web sheet being provided with a plurality of protrusions which are densely arranged for performing sweeping,
wherein the wiper strip has a non-symmetric configuration with respect to a vertical axis, i.e. a y axis, in a horizontal axis, i.e. an x axis, and the non-symmetric configuration is made so that two second grooves are provided between a base plate of a wiping web and a second horizontal plate of the wiper strip, and a depth of the second groove above a half in which the protrusions are provided is smaller than a depth of the second groove above a half in which the smooth surface is present.

17. The wiper blade according to claim 16, wherein the number of the wiper strip is 1 or 2.

18. The wiper blade according to claim 17, wherein in case of two wiper strips, the two wiper strips are arranged parallel to each other, two surfaces which face inward to each other of two web sheets of the two wiper strips are smooth surfaces, and two surfaces which face outward away from each other of the two web sheets of the two wiper strips are provided with the protrusions.

19. The wiper blade according to claim 16, wherein a ratio of a depth d′ of the second groove above the half in which the protrusions are provided to a depth d of the second groove above the half in which the smooth surface is present is within the following range: d′/d=0.2˜0.95.

20. The wiper blade according to claim 16, wherein the non-symmetric configuration is made so that a thickness of the half in which the protrusions are provided of the web sheet is greater than a thickness of the half in which the smooth surface is present of the web sheet.

21. The wiper blade according to claim 16, wherein on one surface or two surfaces of the web sheet of the wiper strip, the plurality of protrusions are arranged into 1˜5 rows above an end surface to be in contact with the windshield glass of the wiper strip in a longitudinal direction of the wiper strip, and cross sections of the protrusions perpendicular to a protruding direction thereof have arched contours.

22. The wiper blade according to claim 21, wherein the cross sections of the protrusions perpendicular to the protruding direction thereof are crescent or circular or elliptic or olivary or spindly.

23. The wiper blade according to claim 21, wherein 2˜5 rows of the protrusions are arranged in the longitudinal direction of the wiper strip, and the protrusions in adjacent two rows are arranged to be staggered with respect to each other.

24. The wiper blade according to claim 21, wherein the protrusions are not connected to each other but separately arranged.

25. The wiper blade according to claim 21, wherein the protrusions in the same row are connected to each other and continuously arranged.

26. The wiper blade according to claim 25, wherein 2˜30 protrusions are connected into a group, one group is disconnected from another group in the same row, and the protrusions of respective groups in adjacent two rows are arranged to be staggered with respect to each other.

27. The wiper blade according to claim 21, wherein the cross sections of the protrusions are tapered in the protruding direction of the protrusions.

28. The wiper blade according to claim 21, wherein an included angle of 30°˜90° is formed between a vertical axis of the wiper strip and an axis in the protruding direction of the protrusions.

29. A wiper blade, characterized in that it comprises
(1) a wiper frame including an elastic main frame, a connector connected to a wiper arm of an automobile, an elastic sub-frame, and a plurality of hanging hooks for hanging-up the sub-frame through the main frame; and
(2) a wiper strip made of rubber hung-up by the sub-frame, the wiper strip having an erective web sheet to be in contact with a windshield glass of the automobile, one surface of the web sheet being a smooth surface, the other surface of the web sheet being provided with a plurality of protrusions which are densely arranged for performing sweeping,
wherein the wiper strip has a non-symmetric configuration with respect to a vertical axis, i.e. a y axis, in a horizontal axis, i.e. an x axis, and the non-symmetric configuration is made so that a second post is provided between a base plate of a wiping web and a second horizontal plate of the wiper strip, and a lower end in a vertical longitudinal direction of the second post is deflected toward a half in which the smooth surface is present of the web sheet with respect to the y axis.

30. The wiper blade according to claim 29, wherein the number of the wiper strip is 1 or 2.

31. The wiper blade according to claim 30, wherein in case of two wiper strips, the two wiper strips are arranged parallel to each other, two surfaces which face inward to each other of two web sheets of the two wiper strips are smooth surfaces, and two surfaces which face outward away from each other of the two web sheets of the two wiper strips are provided with the protrusions.

32. The wiper blade according to claim 29, wherein a deflected angle a by which the vertical direction of the second post is deflected with respect to the y axis is within the range of ∠a=2°˜30°.

33. The wiper blade according to claim 29, wherein the non-symmetric configuration is made so that a thickness of the half in which the protrusions are provided of the web sheet is greater than a thickness of the half in which the smooth surface is present of the web sheet.

34. The wiper blade according to claim 29, wherein on one surface or two surfaces of the web sheet of the wiper strip, the plurality of protrusions are arranged into 1˜5 rows above an end surface to be in contact with the windshield glass of the wiper strip in a longitudinal direction of the wiper strip, and cross sections of the protrusions perpendicular to a protruding direction thereof have arched contours.

35. The wiper blade according to claim 34, wherein the cross sections of the protrusions perpendicular to the protruding direction thereof are crescent or circular or elliptic or olivary or spindly.

36. The wiper blade according to claim 34, wherein 2˜5 rows of the protrusions are arranged in the longitudinal direction of the wiper strip, and the protrusions in adjacent two rows are arranged to be staggered with respect to each other.

37. The wiper blade according to claim 34, wherein the protrusions are not connected to each other but separately arranged.

38. The wiper blade according to claim 34, wherein the protrusions in the same row are connected to each other and continuously arranged.

39. The wiper blade according to claim 38, wherein 2˜30 protrusions are connected into a group, one group is disconnected from another group in the same row, and the protrusions of respective groups in adjacent two rows are arranged to be staggered with respect to each other.

40. The wiper blade according to claim 34, wherein the cross sections of the protrusions are tapered in the protruding direction of the protrusions.

41. The wiper blade according to claim 34, wherein an included angle of 30°˜90° is formed between a vertical axis of the wiper strip and an axis in the protruding direction of the protrusions.

42. A wiper strip of a wiper blade used on a car, the wiper strip comprising a web sheet for contacting a windshield glass, wherein on one surface or two surfaces of the web sheet of the wiper strip, a plurality of protrusions are arranged into 1˜5 rows above an end surface to be in contact with the windshield glass of the wiper strip in a longitudinal direction of the wiper strip, and cross sections of the protrusions perpendicular to a protruding direction thereof have arched contours.

43. The wiper strip of a wiper blade used on a car according to claim 42, wherein the cross sections of the protrusions perpendicular to the protruding direction thereof are crescent or circular or elliptic or olivary or spindly.

44. The wiper strip of a wiper blade used on a car according to claim 42, wherein 2˜5 rows of the protrusions are arranged in the longitudinal direction of the wiper strip, and the protrusions in adjacent two rows are arranged to be staggered with respect to each other.

45. The wiper strip of a wiper blade used on a car according to claim 42, wherein an included angle of 30°˜90° is formed between a vertical axis of the wiper strip and an axis in the protruding direction of the protrusions.
